(19) United States
(12) Patent Application Publication
(10) Pub. No.: US 2012/0043905 A1
(43) Pub. Date: Feb. 23, 2012

(54) Method of Controlling an Operating Frequency of an Inverter Circuit in an Electronic Dimming Ballast

(75) Inventors: Graham L. Christensen, Plymouth Meeting, PA (US); Rebecca A. Merola, Quakertown, PA (US); Thomas M. Shearer, Macungie, PA (US); Dragan Veskovic, Allentown, PA (US)

(73) Assignee: LUTRON ELECTRONICS CO., INC., Coopersburg, PA (US)

(21) Appl. No.: 13/210,865

(22) Filed: Aug. 16, 2011

Related U.S. Application Data
(60) Provisional application No. 61/374,866, filed on Aug. 18, 2010.

(51) Int. Cl. H05B 41/36

(52) U.S. Cl. 315/226

(57) ABSTRACT

An electronic ballast having an inverter circuit for driving a gas discharge lamp prevents allows some hard switching to occur in the inverter circuit in order to ensure adequate ballasting impedance to provide stable operation of the lamp, but not enough hard switching to generate excessive power loss in the inverter circuit. The inverter circuit comprises two switching devices that are coupled in series between a DC bus voltage and circuit common and are rendered conductive on a complementary basis, such that a high-frequency output voltage is generated at the junction of the switching devices. When the intensity of the lamp is at or near a low-end intensity, an operating frequency of the high-frequency output voltage is controlled to a low-end frequency that is low enough to ensure stable operation of the lamp and to allow some hard switching to occur in the switching devices, but high enough to prevent excessive power loss due to the hard switching in the switching devices.

### CROSS-REFERENCE TO RELATED APPLICATIONS

This application is a non-provisional application of commonly-assigned U.S. Provisional Application No. 61/374,866, filed Aug. 18, 2010, entitled METHOD OF CONTROLLING AN OPERATING FREQUENCY OF AN INVERTER CIRCUIT IN AN ELECTRONIC DIMMING BALLAST, the entire disclosure of which is hereby incorporated by reference.

### BACKGROUND OF THE INVENTION

1. Field of the Invention

The present invention relates to an electronic dimming ballast, and more particularly, to a method of adjusting the operating frequency of an inverter circuit of the ballast in response to detecting hard switching in the inverter circuit.

2. Description of the Related Art

Prior art electronic ballasts for fluorescent lamps typically comprise a “front-end” circuit and a “back-end” circuit. The front-end circuit often includes a rectifier for receiving an alternating-current (AC) mains line voltage and producing a rectified voltage V_{RECT}, and a boost converter for receiving the rectified voltage V_{RECT} and generating a direct-current (DC) bus voltage V_{BUS} across a bus capacitor. The boost converter is an active circuit for boosting the magnitude of the DC bus voltage above the peak of the line voltage and for improving the total harmonic distortion (THD) and the power factor of the input current to the ballast. The back-end circuit typically includes a switching inverter circuit having switching devices for converting the DC bus voltage V_{BUS} to a high-frequency AC inverter output voltage V_{INV} (e.g., a square-wave voltage) and a resonant tank circuit for generating a sinusoidal voltage V_{SIN} from the inverter output voltage V_{INV} and coupling the sinusoidal voltage V_{SIN} to the lamp electrodes.

Some prior art dimming ballasts have controlled the amount of power delivered to the lamp by adjusting an operating frequency f_{OP} of the inverter output voltage V_{INV} to thus control the intensity of the lamp from a low-end intensity L_{LE} to a high-end intensity L_{HE}. An example of such a prior art ballast is described in greater detail in U.S. Pat. No. 7,408,307, issued Aug. 5, 2008, entitled BALLAST DIMMING CONTROL IC (herein referred to as the '307 patent). The ballast of the '307 patent controls the operating frequency f_{OP} to a minimum operating frequency f_{MIN} when the intensity of the lamp is near the high-end intensity L_{HE}, and to a maximum operating frequency f_{MAX} when the intensity of the lamp is near the low-end intensity L_{LE}. The ballast of the '307 patent sets the minimum frequency f_{MIN} as close a possible to a low-Q resonance frequency of the resonant tank circuit when the intensity of the lamp is near the high-end intensity L_{HE}. However, if the operating frequency f_{OP} is controlled too close to the resonant frequency, reverse recovery and hard switching may occur in the switching devices in the inverter circuit, which may result in noise and increased temperatures in the inverter circuit. To solve this issue, the ballast of the '307 patent controls the switching devices of the inverter circuit to be conductive only when there is zero voltage across the switching device.

Some other prior art dimming ballasts have controlled the amount of power delivered to the lamp by adjusting a duty cycle DC_{SQ} of the inverter output voltage V_{INV} to thus control the intensity of the lamp from the low-end intensity L_{LE} to the high-end intensity L_{HE}. In such ballasts, the operating frequency f_{OP} of the inverter output voltage may be held constant for much of the dimming range of the lamp between the low-end intensity L_{LE} to the high-end intensity L_{HE}. As previously mentioned, the operating frequency f_{OP} of the inverter output voltage V_{INV} cannot be controlled too close to the resonant frequency f_{RES}, because reverse recovery and hard switching may occur in the switching devices of the inverter circuit, thus causing the temperatures of the switching devices to increase. However, increasing the operating frequency f_{OP} of the inverter output voltage V_{INV} too far away from the resonant frequency f_{RES} is fraught with the demons of unstable lamp performance as described in commonly-assigned U.S. Pat. No. 5,041,763, issued Aug. 20, 1991, entitled CIRCUIT AND METHOD FOR IMPROVED DIMMING OF GAS DISCHARGE LAMPS, the entire disclosure of which is hereby incorporated by reference. Therefore, to provide for stabile lamp operation to thus avoid flickering in the lamp, the operating frequency f_{OP} of the inverter output voltage is controlled to be low enough (e.g., to a low-end frequency f_{LE} that is slightly above a resonant frequency f_{RES}), such that the resonant tank circuit provides an appropriate amount of output impedance to the lamp when controlled to the low-end intensity L_{LE}.

Therefore, for a dimming ballast that controls the amount of power delivered to the lamp by adjusting the duty cycle DC_{SQ} of the inverter output voltage V_{INV}, there is only a small frequency window above the resonant frequency f_{RES} in which the operating frequency f_{OP} of the inverter output voltage V_{INV} must be controlled when the lamp is at the low-end intensity L_{LE}. In addition, the size of the frequency window in which the operating frequency f_{OP} may be controlled when the lamp is at the low-end intensity L_{LE} is further reduced by the tolerances of the components of the resonant tank circuit. Accordingly, there is a need for an electronic dimming ballast that is able to adjust the duty cycle DC_{SQ} of the inverter output voltage V_{INV} to dim the lamp and to more accurately control the operating frequency f_{OP} of the inverter output voltage V_{INV} near the low-end intensity L_{LE} to avoid reverse recovery in the inverter circuit and to provide adequate ballasting impedance.

### SUMMARY OF THE INVENTION

According to an embodiment of the present invention, an electronic ballast having an inverter circuit for driving a gas discharge lamp allows some hard switching to occur in the inverter circuit in order to ensure adequate ballasting impedance to provide stable operation of the lamp, but not enough hard switching to generate excessive power loss in the inverter circuit. The inverter circuit converts a DC bus voltage to a high-frequency inverter output voltage having an operating frequency and an operating duty cycle, and comprises first and second series-connected switching devices coupled between the bus voltage and circuit common. The first and second switching devices are rendered conductive and non-conductive on a complementary basis, such that the high-frequency inverter output voltage is generated at the junction of the switching devices. The ballast further comprises a resonant tank circuit operable to couple the high-frequency inverter output voltage to the lamp, and a control circuit coupled to the inverter circuit for controlling the operating duty cycle of the high-frequency inverter output voltage, so as to adjust the intensity of the lamp to a target intensity. When the intensity of the lamp is at or near a low-end intensity, the control circuit controls the operating frequency of the high-frequency inverter output voltage to a low-end operating frequency that is low enough to ensure stable operation of the lamp and to allow some hard switching to occur in the switching devices of the inverter circuit, but high enough to prevent excessive power loss due to the hard switching in the switching devices of the inverter circuit.

The ballast may further comprise a hard switching detection circuit operable to determine the amount of hard switching that is presently occurring in the switching devices of the inverter circuit, and to generate a control signal representative of the amount of hard switching that is presently occurring in the switching devices of the inverter circuit. The hard switching detection circuit may determine the amount of hard switching that is presently occurring in the switching devices of the inverter circuit in response to the magnitude of the high-frequency inverter output voltage immediately before the first switching device is rendered conductive. The control circuit adjusts the operating frequency of the high-frequency inverter output voltage in response to the amount of hard switching that is presently occurring.

In addition, a method for driving a gas discharge lamp in an electronic ballast is also described herein. The method comprises: (1) converting a DC bus voltage to a high-frequency inverter output voltage having an operating frequency and an operating duty cycle using first and second series-connected switching devices coupled between the bus voltage and circuit common, the first and second switching devices rendered conductive and non-conductive on a complementary basis, such that the high-frequency inverter output voltage is generated at the junction of the switching devices; (2) controlling the operating duty cycle of the high-frequency inverter output voltage so as to adjust the intensity of the lamp to a target intensity; (3) controlling the operating frequency of the high-frequency inverter output voltage to a low-end operating frequency when the intensity of the lamp is at or near a low-end intensity; (4) generating a control signal representative of an amount of hard switching that is presently occurring in the series-connected switching devices; and (5) adjusting the operating frequency of the high-frequency inverter output voltage in response to the control signal representative of the amount of hard switching that is presently occurring to ensure stable operation of the lamp, allow some hard switching to occur in the series-connected switching devices, and prevent excessive power loss due to the hard switching in the series-connected switching devices.

Other features and advantages of the present invention will become apparent from the following description of the invention that refers to the accompanying drawings.

### BRIEF DESCRIPTION OF THE DRAWINGS

The invention will now be described in greater detail in the following detailed description with reference to the drawings in which:

FIG. 1 is a simplified block diagram of an electronic dimming ballast for driving a fluorescent lamp according to a first embodiment of the present invention;

FIG. 2 is a simplified chart illustrating the possible range in which an operating frequency of an inverter circuit of the ballast of FIG. 1 may be controlled when a target intensity of the lamp is at or near a low-end intensity;

FIG. 3 is a simplified diagram showing example waveforms illustrating the operation of the ballast of FIG. 1 when reverse recovery is not occurring in the inverter circuit;

FIG. 4 is a simplified diagram showing example waveforms illustrating the operation of the ballast of FIG. 1 when reverse recovery is occurring in the inverter circuit;

FIG. 5 is a simplified schematic diagram of a hard switching detect circuit of the ballast of FIG. 1;

FIG. 6 is a simplified flowchart of a target intensity adjustment procedure executed by a microprocessor of the ballast of FIG. 1 in response to changes to the target intensity;

FIG. 7 is a simplified flowchart of an enable control signal procedure executed by the microprocessor of the ballast of FIG. 1;

FIG. 8 is a simplified flowchart of a hard switching detect procedure executed by the microprocessor of the ballast of FIG. 1;

FIG. 9 is a simplified flowchart of the hard switching offset frequency adjustment procedure executed periodically by the microprocessor of the ballast of FIG. 1;

FIG. 10 is a simplified block diagram of an electronic dimming ballast according to a second embodiment of the present invention;

FIG. 11 is a simplified schematic diagram of a hard switching detect circuit of the ballast of FIG. 10 according to the second embodiment of the present invention; and

FIG. 12 is a simplified flowchart of a hard switching offset frequency adjustment procedure executed periodically by microprocessor of the ballast of FIG. 10 according to the second embodiment of the present invention.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

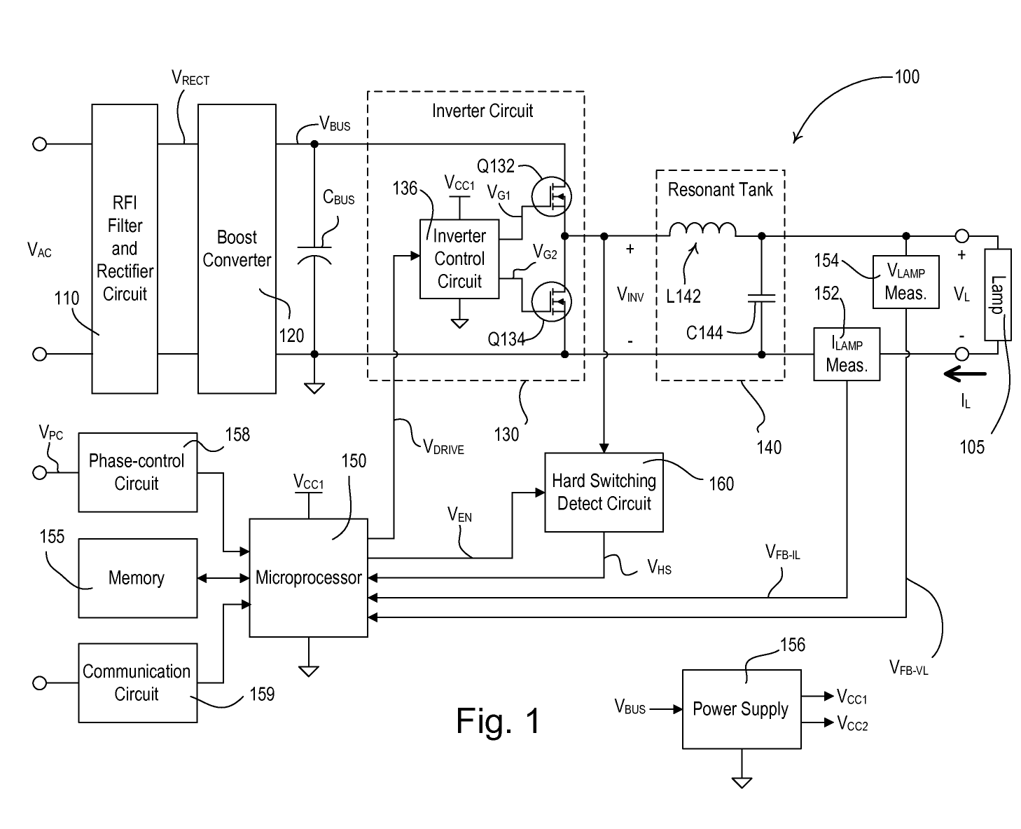

FIG. 1 is a simplified block diagram of an electronic dimming ballast 100 according to a first embodiment of the present invention. The ballast 100 comprises a hot terminal H and a neutral terminal N that are adapted to be coupled to an alternating-current (AC) power source (not shown) for receiving an AC mains line voltage V_{AC}. The ballast 100 is adapted to be coupled between the AC power source and a gas discharge lamp (e.g., a fluorescent lamp 105), such that the ballast is operable to control the amount of power delivered to the lamp and thus the intensity of the lamp. The ballast 100 comprises an RFI (radio frequency interference) filter and rectifier circuit 110 for minimizing the noise provided on the AC mains, and producing a rectified voltage V_{RECT} from the AC mains line voltage V_{AC}. The ballast 100 further comprises a boost converter 120 for generating a direct-current (DC) bus voltage V_{BUS} across a bus capacitor C_{BUS}. The DC bus voltage V_{BUS} typically has a magnitude (e.g., 465 volts) that is greater than the peak magnitude V_{PK} of the AC mains line voltage V_{AC} (e.g., 170 volts). The boost converter 120 also operates as a power-factor correction (PFC) circuit for improving the power factor of the ballast 100. The ballast 100 also includes an inverter circuit 130 that comprises a inverter control circuit 136 and converts the DC bus voltage V_{BUS} to a high-frequency inverter output voltage V_{INV} (e.g., a square-wave voltage). A resonant tank circuit 140 couples the inverter output voltage generated by the inverter circuit to filaments of the lamp 105.

The ballast 100 further comprises a control circuit, e.g., a microprocessor 150, which is coupled to the inverter circuit 130 for turning the lamp 105 on and off and adjusting the intensity of the lamp 105 to a target intensity L_{TARGET} between a low-end (i.e., minimum) intensity L_{LE} (e.g., 1%) and a high-end (i.e., maximum) intensity L_{HE} (e.g., 100%). The microprocessor 150 may alternatively be implemented as a microcontroller, a programmable logic device (PLD), an application specific integrated circuit (ASIC), or any suitable type of controller or control circuit. The microprocessor 150 provides a drive control signal V_{DRIVE} to the inverter circuit 130 and may control one or both of two operational parameters of the inverter circuit (e.g., an operating frequency f_{OP} and an operating duty cycle DC_{SQ}) to control the magnitudes of a lamp voltage V_{L} generated across the lamp 105 and a lamp current I_{L} conducted through the lamp. The microprocessor 150 receives a lamp current feedback signal V_{FB-IL}, which is generated by a lamp current measurement circuit 152 and is representative of the magnitude of the lamp current I_{L}. The microprocessor 150 also receives a lamp voltage feedback signal V_{FB-IL}, which is generated by a lamp voltage measurement circuit 154 and is representative of the magnitude of the lamp voltage V_{L}.

The ballast 100 also comprises a memory 155, which is coupled to the microprocessor 150 for storing the target intensity L_{TARGET} and other operational characteristics of the ballast. The memory 155 may be implemented as an external integrated circuit (IC) or as an internal circuit of the microprocessor 150. A power supply 156 receives the bus voltage V_{BUS} and generates a first DC supply voltage V_{CC1} (e.g., approximately 15 volts) for powering the inverter control circuit 136 of the inverter circuit 130 and a second DC supply voltage V_{CC2} (e.g., approximately 5 volts) for powering the microprocessor 150, the memory 155, and other low-voltage circuitry of the ballast 100.

The ballast 100 may comprise a phase-control circuit 158 for receiving a phase-control voltage V_{PC} (e.g., a forward or reverse phase-control signal) from a standard phase-control dimmer (not shown). The microprocessor 150 is coupled to the phase-control circuit 158, such that the microprocessor is operable to determine the target intensity L_{TARGET} for the lamp 105 from the phase-control voltage V_{PC}. The ballast 100 may also comprise a communication circuit 159, which is coupled to the microprocessor 150 and allows the ballast to communicate (i.e., transmit and receive digital messages) with other control devices on a communication link (not shown), e.g., a wired communication link or a wireless communication link, such as a radio-frequency (RF) or an infrared (IR) communication link. Examples of ballasts having communication circuits are described in greater detail in commonly-assigned U.S. Pat. No. 7,489,090, issued Feb. 10, 2009, entitled ELECTRONIC BALLAST HAVING ADAPTIVE FREQUENCY SHIFTING; U.S. Pat. No. 7,528,554, issued May 5, 2009, entitled ELECTRONIC BALLAST HAVING A BOOST CONVERTER WITH AN IMPROVED RANGE OF OUTPUT POWER; and U.S. Pat. No. 7,764,479, filed Jul. 27, 2010, entitled COMMUNICATION CIRCUIT FOR A DIGITAL ELECTRONIC DIMMING BALLAST, the entire disclosures of which are hereby incorporated by reference.

The inverter circuit 130 comprises first and second series-connected switching devices, e.g., field-effect transistors (FETs) Q132, Q134, coupled between the bus voltage V_{BUS} and circuit common. The inverter control circuit 136 provides respective gate voltages V_{G1}, V_{G2} to the FETs to control the FETs in response to the drive control signal V_{DRIVE} from the microprocessor 150, so as to generate the high-frequency inverter output voltage V_{INV} at the junction of the FETs Q132, Q134. The inverter control circuit 136 controls each of the first and second gate voltages V_{G1}, V_{G2} to a nominal gate voltage V_{GN} (e.g., approximately nine volts) to render the respective FET Q132, Q134 conductive. The inverter control circuit 136 may comprise, for example, an integrated circuit (IC), such as part number NCP5111, manufactured by On Semiconductor. The inverter control circuit 136 may control the FETs Q132, Q134 using a d(1−d) complementary switching scheme, in which the first FET Q132 has a duty cycle of d (i.e., equal to the duty cycle DC_{SQ}) and the second FET Q134 has a duty cycle of 1-d, such that only one FET is conducting at a time. The inverter control circuit 136 renders the first FET Q132 conductive when the drive control signal V_{DRIVE} is driven high (i.e., to approximately the DC supply voltage V_{cc}), and renders the second FET Q134 conductive when the drive control signal V_{DRIVE} is driven low (i.e., to approximately circuit common). When the first FET Q132 is conductive, the output of the inverter circuit 130 is pulled up towards the bus voltage V_{BUS}. When the second FET Q134 is conductive, the output of the inverter circuit 130 is pulled down towards circuit common. The magnitude of the lamp current I_{L} conducted through the lamp 105 is controlled by adjusting the operating frequency f_{OP} and/or the duty cycle DC_{OP} of the high-frequency inverter output voltage V_{INV} generated by the inverter circuit 130.

The resonant tank circuit 140 includes a resonant inductor L142 adapted to be coupled in series between the inverter circuit 130 and the lamp 105, and a resonant capacitor C144 adapted to be coupled in parallel with the lamp. For example, the inductor L142 may have an inductance L₁₄₂ of approximately 1.7 mH, while the resonant capacitor C144 may have a capacitance C₁₄₄ of approximately 1.2 nF. The resonant tank circuit 140 is characterized by a resonant frequency f_{RES}, i.e.,

f_{RES}=1/√(L₁₄₂·C₁₄₄),

such that the unloaded resonant frequency f_{RES} may be, for example, approximately 70 kHz. When the target intensity L_{TARGET} of the lamp 105 is at or near the low-end intensity L_{LE}, the microprocessor 150 controls the operating frequency f_{OP} to be close to the resonant frequency f_{RES} to provide an appropriate ballasting impedance for stable lamp operation, but not so close to the resonant frequency that reverse recovery occurs in the body diodes of the FETs Q132, Q134 of the inverter circuit 130. Specifically, when the target intensity L_{TARGET} is less than or equal to a threshold intensity L_{TH} (e.g., approximately 50%), the operating frequency f_{OP} is controlled to a low-end operating frequency f_{LE} (e.g., approximately 75 kHz). When the target intensity L_{TARGET} is greater than the threshold intensity L_{TH}, the operating frequency f_{OP} may be adjusted below the low-end operating frequency f_{LE} in response to the target intensity L_{TARGET} of the lamp 105 (e.g., to decrease the operating frequency f_{OP} as the target intensity L_{TARGET} increases according to a predetermined relationship).

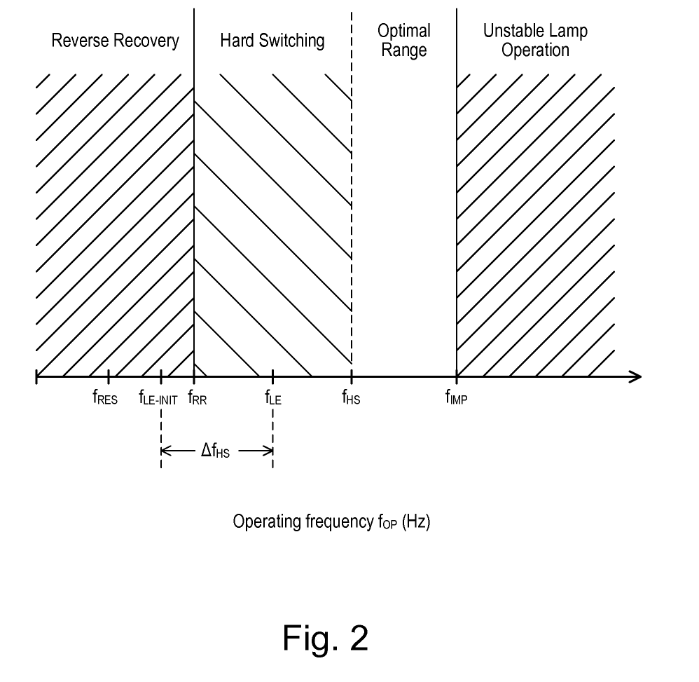

FIG. 2 is a simplified chart illustrating the possible range (i.e., the window) in which the operating frequency f_{OP} may be controlled when the target intensity L_{TARGET} of the lamp 105 is at or near the low-end intensity L_{LE} (i.e., when the target intensity L_{TARGET} is less than or equal to the threshold intensity L_{TH}). If the operating frequency f_{OP} is controlled below a hard-switching frequency f_{HS}, some hard switching may occur in the FETs Q132, Q134. Controlling the operating frequency f_{OP} to be below a reverse-recovery frequency f_{RR} may result in reverse recovery in the FETs Q132, Q134, which may damage the FETs. Ideally, the operating frequency f_{OP} is controlled to be greater than both the reverse-recovery frequency f_{RR} and the hard-switching frequency f_{HS}. However, when operating at or near the low-end intensity L_{LE}, the operating frequency f_{OP} must be controlled to be less than a ballasting-impedance frequency f_{IMP}. If the operating frequency f_{OP} is controlled above the ballasting-impedance frequency f_{IMP}, the resonant tank circuit 140 may not be able to provide an appropriate ballasting impedance thus resulting in unstable lamp operation. Accordingly, in the ideal situation, the operating frequency f_{OP} may only be adjusted in a small window between the hard-switching frequency f_{HS} and the ballasting-impedance frequency f_{IMP} when the target intensity L_{TARGET} of the lamp 105 is at or near the low-end intensity L_{LE}.

According to an aspect the present invention, the operating frequency f_{OP} may be controlled below the hard-switching frequency f_{HS} to allow some hard switching of the FETs Q132, Q134, but not enough hard switching to result in significant power dissipation and temperature rise in the FETs. Specifically, when the target intensity L_{TARGET} of the lamp 105 is at or near the low-end intensity L_{LE}, the microprocessor 150 controls the operating frequency f_{OP} of the inverter output voltage V_{INV} to be low enough (i.e., close enough to the resonant frequency f_{RES}) to ensure stable operation of the lamp and to allow some hard switching to occur in the FETs Q132, Q134 of the inverter circuit 130, but high enough (i.e., far enough from the resonant frequency f_{RES}) to prevent excessive power loss due to the hard switching in the FETs. In addition, the operating frequency f_{OP} is control to be high enough such that reverse recovery in the body diodes of the FETs is avoided.

Referring back to FIG. 1, the ballast 100 further comprises a hard switching detection circuit 160, which is coupled to the inverter circuit 130 for receiving the inverter output voltage V_{INV}. The hard switching detection circuit 160 generates a hard switching control signal V_{HS}, which is representative of the amount of hard switching that is presently occurring in the FETs Q132, Q134. The hard switching control signal V_{HS} is received by the microprocessor 150, such that microprocessor is operable to determine the amount of hard switching that is be occurring in the FETs Q132, Q134. The microprocessor 150 generates an enable control signal V_{EN} for enabling and disabling the hard switching detection circuit 160 as will be described in greater detail below.

When the microprocessor 150 is first powered up, the low-end operating frequency f_{LE} is initialized to an initial low-end operating frequency f_{LE-INIT} (e.g., approximately 75 kHz) and the microprocessor 150 is operable to control the operating frequency f_{OP} to the initial low-end operating frequency f_{LE-INIT} when the target intensity L_{TARGET} of the lamp 105 is at or near the low-end intensity L_{LE}. If the microprocessor 150 determines that an unacceptable amount of hard switching is occurring in the FETs Q132, Q134 (e.g., the operating frequency f_{OP} is below the reverse-recovery frequency f_{RR}) when the operating frequency f_{OP} is being controlled to the low-end frequency f_{LE}, the microprocessor is operable to increase the low-end operating frequency f_{LE} by a hard switching offset frequency Δf_{HS}. Specifically, the microprocessor 150 is operable to step the operating frequency f_{OP} up by a predetermined amount Δf_{LE} (e.g., approximately 1 kHz) until an acceptable amount of hard switching is occurring in the FETs Q132, Q134. The microprocessor 150 does not control the low-end frequency f_{LE} to be greater than a maximum low-end frequency f_{LE-MAX}, which may have a value that is dependent upon the component tolerances of the resonant tank circuit 140 (e.g., approximately 10% greater than the initial low-end operating frequency f_{LE-INIT}, i.e., f_{LE-MAX}=1.10·f_{LE-INIT}). Accordingly, the microprocessor 150 adjusts the low-end frequency f_{LE} in a range between the initial low-end operating frequency f_{LE-INIT} and the maximum low-end frequency f_{LE-MAX}.

The initial low-end operating frequency f_{LE-INIT} may be stored in the memory 155 during manufacturing of the ballast. Alternatively, the microprocessor 150 could be operable to execute a resonant frequency detection procedure in order to determine an approximation of (i.e., measure) the resonant frequency f_{RES} of the resonant tank circuit 140, and then use the measured resonant frequency f_{RES} to determine the initial low-end operating frequency f_{LE-INIT} of the ballast 100, as described in greater detail in U.S. Provisional patent application Ser. No. 12/858,662, filed Aug. 18, 2010, entitled METHOD OF CONTROLLING AN OPERATING FREQUENCY OF AN ELECTRONIC DIMMING BALLAST, the entire disclosure of which is hereby incorporated by reference. For example, the initial low-end operating frequency f_{LE-INIT} may be equal to approximately the measured resonant frequency f_{RES} (from the resonant frequency detection procedure 300) plus an offset frequency f_{OFFSET} (e.g., approximately two kHz).

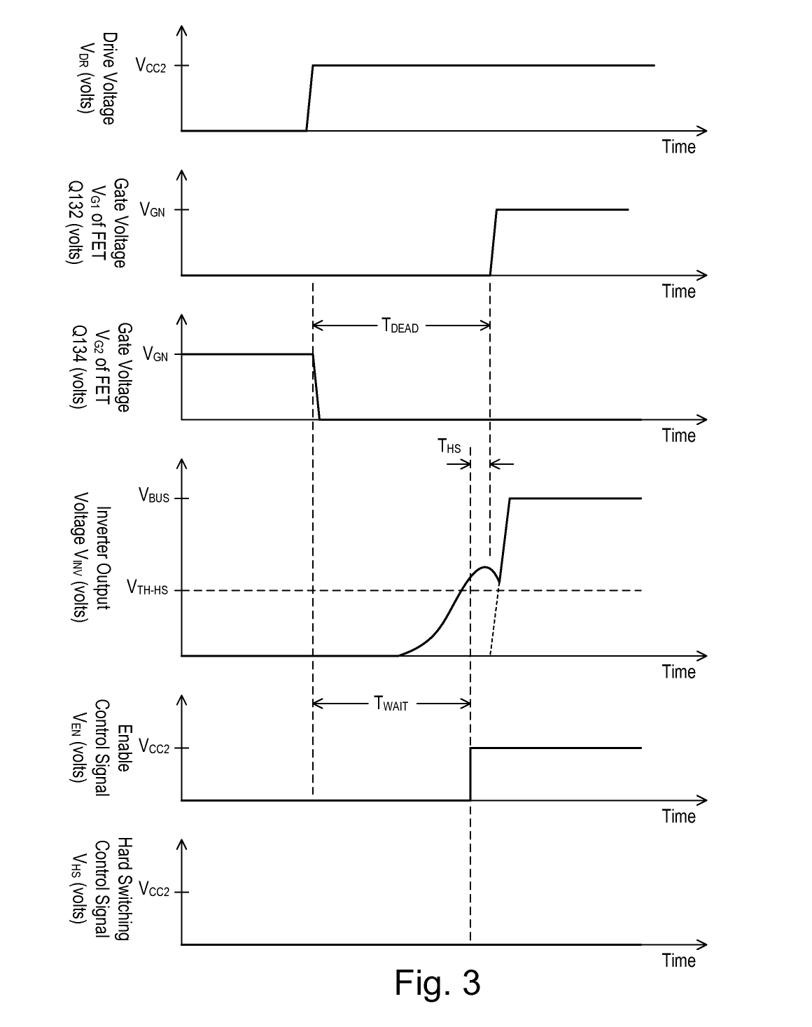

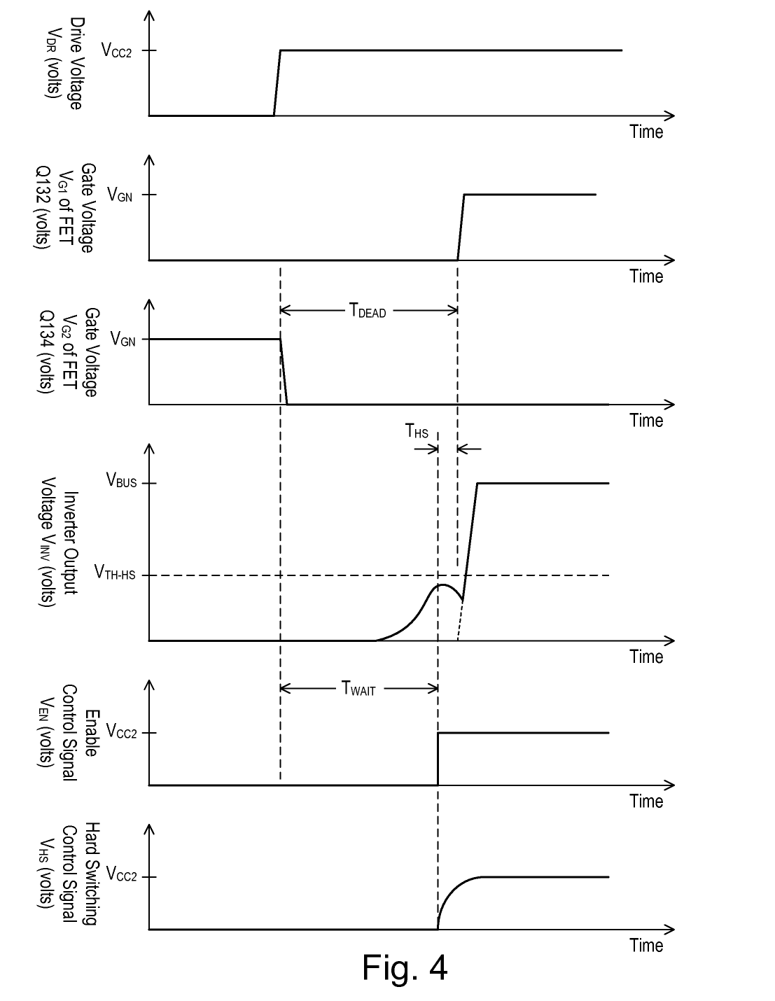

FIG. 3 and FIG. 4 are simplified diagrams showing example waveforms illustrating the operation of the ballast 100 when an acceptable amount of hard switching is occurring in the FETs Q132, Q134 and when an unacceptable amount of hard switching is occurring in the FETs, respectively. When the microprocessor 150 drives the drive control signal V_{DRIvE} high (i.e., to approximately the second DC supply voltage V_{CC2}), the inverter control circuit 136 immediately drives the second gate voltage V_{G2} of the second FET Q134 low to render the second FET non-conductive. The inverter control circuit 136 then waits for a deadtime period T_{DEAD} before driving the first gate voltage V_{G1} of the first FET Q132 high to the nominal gate voltage V_{GN} to render the first FET conductive. During the deadtime period T_{DEAD} after the second FET Q134 is rendered non-conductive, current continues to flow through the resonant inductor L142 of the resonant tank circuit 140 and charges the parasitic capacitances of the FETs Q132, Q134, such that the magnitude of the inverter output voltage V_{INV} increases as shown in FIG. 3.

The microprocessor 150 is operable to enable the hard switching detection circuit 160 to determine the amount of hard switching that is occurring a predetermined time period T_{HS} (e.g., approximately 100 nanoseconds) before the inverter control circuit 136 drives the first gate voltage V_{G1} high to render the first FET Q132 conductive. Specifically, the microprocessor 150 waits for a wait time period T_{WAIT} (e.g., approximately 750 nanoseconds) after driving the drive control signal V_{DRIVE} high. At the end of the wait time period T_{WAIT}, the microprocessor 150 drives the enable control signal V_{EN} high (as shown in FIG. 3), such that the microprocessor may begin to monitor the hard switching control signal V_{HS}. The hard switch detection circuit 160 drives the hard switching control signal V_{HS} high if an unacceptable amount of hard switching may be occurring in the FETs Q132, Q134. Specifically, the hard switching detection circuit 160 is operable to signal that an acceptable amount of hard switching is occurring in the FETs Q132, Q134 if the magnitude of the inverter output voltage V_{INV} exceeds a predetermined hard switching threshold V_{TH-HS} (e.g., approximately 36 volts) as shown in FIG. 3, and to signal that an unacceptable amount of hard switching is occurring in the FETs if the magnitude of the inverter output voltage V_{INV} does not exceed the predetermined hard switching threshold V_{TH-HS} as shown in FIG. 4.

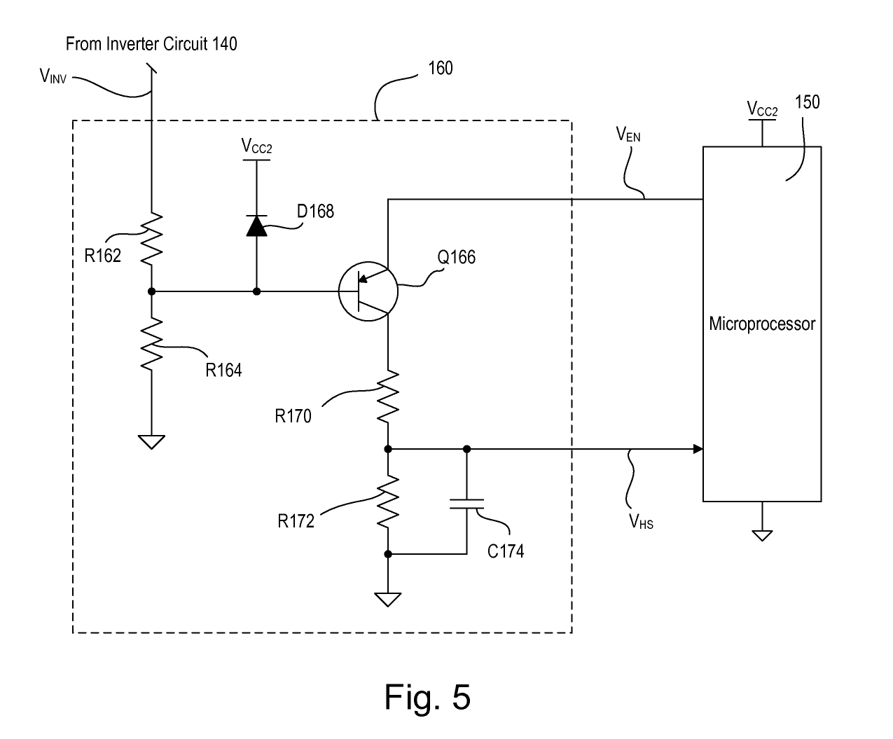

FIG. 5 is a simplified schematic diagram of the hard switching detect circuit 160. The hard switching detect circuit 160 receives the inverter output voltage V_{INV} (i.e., the voltage across the second FET Q134 of the inverter circuit 130), which is coupled across a voltage divider having two resistors R162, R164 (e.g., having resistances of approximately 475 kΩ and 365 kΩ, respectively). The junction of the resistors R162, R164 is coupled to the base of a PNP bipolar junction transistor Q166. The base of a PNP bipolar junction transistor Q166 is also coupled to the second DC supply voltage V_{CC2} through a diode D168 to prevent the voltage at the base of the transistor from rising above approximately the DC supply voltage plus the forward voltage of the diode. The emitter of the transistor Q166 is coupled to the enable control signal V_{EN} received from the microprocessor 150. The collector of the transistor Q166 is coupled to circuit common through two resistors R170, R172 (e.g., having resistances of approximately 392Ω and 10 kΩ, respectively). The junction of the resistors R170, R172 is coupled to circuit common through a capacitor C174 (e.g., having a capacitance of approximately 220 pF), and generates the hard switching control signal V_{HS}, which is received at an interrupt pin on the microprocessor 150, which features a Schmitt-trigger input.

When the microprocessor 150 drives the enable control signal V_{EN} high (i.e., to approximately the second DC supply voltage V_{CC2}), and the magnitude of the inverter output voltage V_{INV} exceeds the predetermined hard switching threshold V_{TH-HS}, the transistor Q166 of the hard switching detection circuit 160 remains non-conductive, and magnitude of the hard switching control signal V_{HS} remains at approximately zero volts. Accordingly, the microprocessor 150 is operable to determine that an acceptable amount of hard switching is occurring in the FETs Q132, Q134 if the hard switching control signal V_{HS} remains at approximately zero volts as shown in FIG. 3. If the magnitude of the inverter output voltage V_{INV} does not rise above the predetermined hard switching threshold V_{TH-HS} when the microprocessor 150 drives the enable control signal V_{EN} high, the transistor Q166 of the hard switching detection circuit 160 is rendered conductive and the capacitor C174 begins to charge towards the second DC supply voltage V_{CC2}. The microprocessor 150 is operable to determine that an unacceptable amount of hard switching is occurring in the FETs Q132, Q134 in response to the voltage pulse generated in the hard switching control signal V_{HS} as shown in FIG. 4.

Alternatively, the hard switching detection circuit 160 could monitor the voltage across the first FET Q132 of the inverter circuit 130 (i.e., the difference between the bus voltage V_{BUS} and the inverter output voltage V_{INV}), and determine if an unacceptable amount of hard switching is occurring in the inverter circuit 130 if the voltage across the first FET Q132 is greater than a predetermined switch voltage threshold V_{TH-SW} (e.g., approximately 429 volts) immediately before the first FET Q132 is rendered conductive. In addition, the hard switching detection circuit 160 could alternatively monitor the current conducted through the second FET Q134, and determine if an unacceptable amount of hard switching is occurring if the current through the second FET Q134 is greater than a predetermined switch current threshold I_{TH-SW} immediately after the first FET Q132 is rendered conductive. For example, the predetermined switch current threshold I_{TH-SW} may be approximately two amps for a ballast that is driving two 54-W lamps.

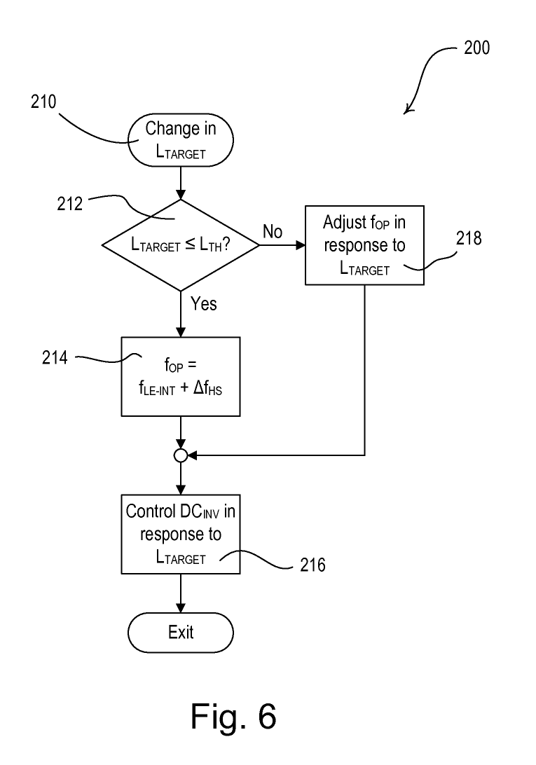

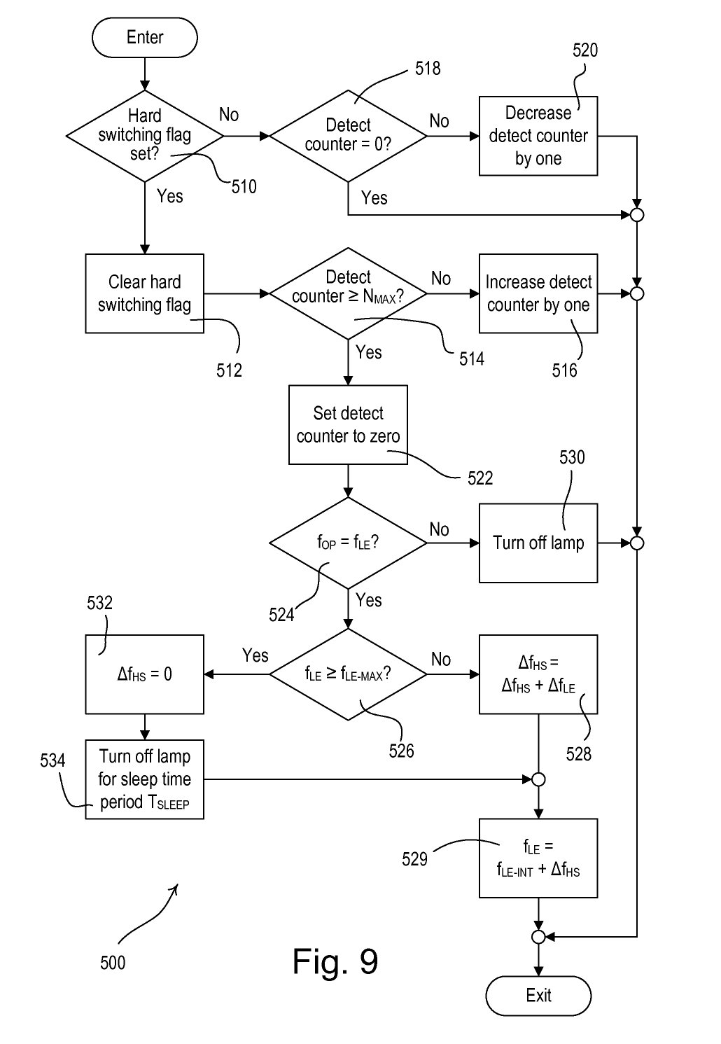

FIG. 6 is a simplified flowchart of a target intensity adjustment procedure 200, which is executed by the microprocessor 150 in response to changes to the target intensity L_{TARGET} at step 210. If the target intensity L_{TARGET} is less than or equal to the threshold intensity L_{TH} (i.e., approximately 50%) at step 212, the microprocessor 150 controls the operating frequency f_{OP} to be equal to the low-end operating frequency f_{LE} (i.e., the initial low-end operating frequency f_{LE-INIT} plus the hard switching offset frequency Δf_{HS}) at step 214. For example, the hard switching offset frequency Δf_{HS} may be initialized to zero Hertz when the ballast 100 is first powered up, and may be adjusted as part of a hard switching offset frequency adjustment procedure 500, which will be described in greater detail below with reference to FIG. 9. The microprocessor 150 then controls the duty cycle DC_{SQ} of the inverter output voltage V_{INV} of the inverter circuit 130 in response to the target intensity L_{TARGET} at step 216, and the target intensity adjustment procedure 200 exits. If the target intensity L_{TARGET} is greater than the threshold intensity L_{TH} at step 212, the microprocessor 150 adjusts the operating frequency f_{OP} in response to the target intensity L_{TARGET} at step 218, and controls the duty cycle DC_{SQ} of the inverter output voltage V_{INV} in response to the target intensity L_{TARGET} at step 216, before the target intensity adjustment procedure 200 exits.

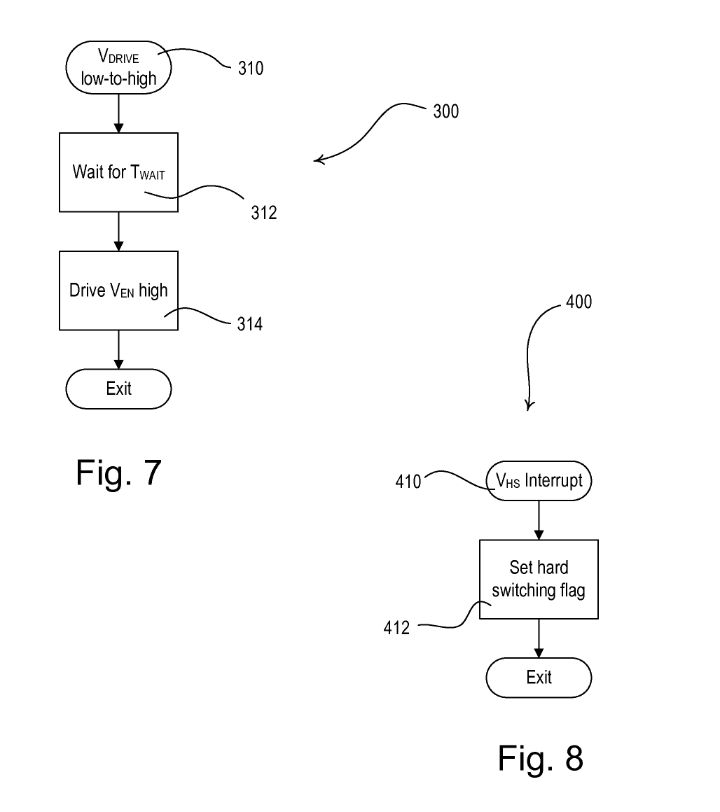

FIG. 7 is a simplified flowchart of an enable control signal procedure 300, which is executed by the microprocessor 150 when the microprocessor drives the drive control signal V_{DRIVE} high at step 310. The microprocessor 150 simply waits for the wait time period T_{WAIT} at step 312 and then drives the enable control signal V_{EN} high at step 314, before the enable control signal procedure 300 exits. The microprocessor 150 is operable to drive the enable control signal V_{EN} low at the same time that the microprocessor drives the drive control signal V_{DRIVE} low.

FIG. 8 is a simplified flowchart of a hard switching detect procedure 400, which is executed by the microprocessor 150 in response to the hard switching control signal V_{HS} received at the interrupt pin of the microprocessor. When the hard switching control signal V_{HS} is driven high to generate the interrupt at step 410, the microprocessor 150 sets a hard switching flag at step 412, and the hard switching detect procedure 400 exits.

FIG. 9 is a simplified flowchart of the hard switching offset frequency adjustment procedure 500, which is executed periodically by the microprocessor 150, e.g., every 104 microseconds. During the hard switching offset frequency adjustment procedure 500, the microprocessor 150 uses a detect counter to keep track of how many times (i.e., how many switching cycles of the inverter circuit 130) that hard switching detection circuit 160 has detected that the FETs Q132, Q134 are operating with an unacceptable amount of hard switching. The microprocessor 150 is operable to increase low-end frequency f_{LE} by the predetermined amount Δf_{LE} when the detect counter reaches a maximum number N_{MAX} (e.g., 20) of detections.

Referring to FIG. 9, if the hard switching flag is set at step 510, the microprocessor 150 clears the hard switching flag at step 512. If the detect counter is less than the maximum number N_{MAX} of detections at step 514, the microprocessor 150 increases the detect counter by one at step 516, and the hard switching offset frequency adjustment procedure 500 exits. If the hard switching flag is not set at step 510, and the detect counter is not equal to zero at step 518, the microprocessor 150 decreases the detect counter by one at step 520, before the hard switching offset frequency adjustment procedure 500 exits. When the detect counter is greater than or equal to the maximum number N_{MAX} of detections at step 514, the microprocessor 150 resets the detect counter to zero at step 522. If the operating frequency f_{OP} is equal to the low-end operating frequency f_{LE} at step 524, and the low-end frequency f_{LE} is less than the maximum low-end frequency f_{LE-MAX} at step 526, the microprocessor 150 increases the hard switching offset frequency Δf_{HS} by the by the predetermined amount Δf_{LE} at step 528. The microprocessor 150 then sets the low-end frequency f_{LE} to be equal to the initial low-end operating frequency f_{LE-INIT} plus the hard switching offset frequency Δf_{HS} at step 529, which thus increases the operating frequency f_{OP}, before the hard switching offset frequency adjustment procedure 500 exits.

If the operating frequency f_{OP} is not equal to the low-end operating frequency f_{LE} at step 524, the microprocessor 150 determines that there is a fault condition in the lamp 105 and turns the lamp off at step 530. If the low-end frequency f_{LE} is greater than or equal to the maximum low-end frequency f_{LE-MAX} at step 526, the microprocessor 150 resets the hard switching offset frequency Δf_{HS} to zero Hertz at step 532 (such that the low-end operating frequency f_{LE} and thus the operating frequency f_{OP} will once again be equal to the initial low-end operating frequency f_{LE-INIT}). At step 534, the microprocessor 150 turns the lamp 105 off for a sleep time period T_{SLEEP} (e.g., approximately five seconds), and the hard switching offset frequency adjustment procedure 500 exits. After the sleep time period T_{SLEEP}, the microprocessor 150 may once again execute the hard switching offset frequency adjustment procedure 500 to adjust the hard switching offset frequency Δf_{HS}.

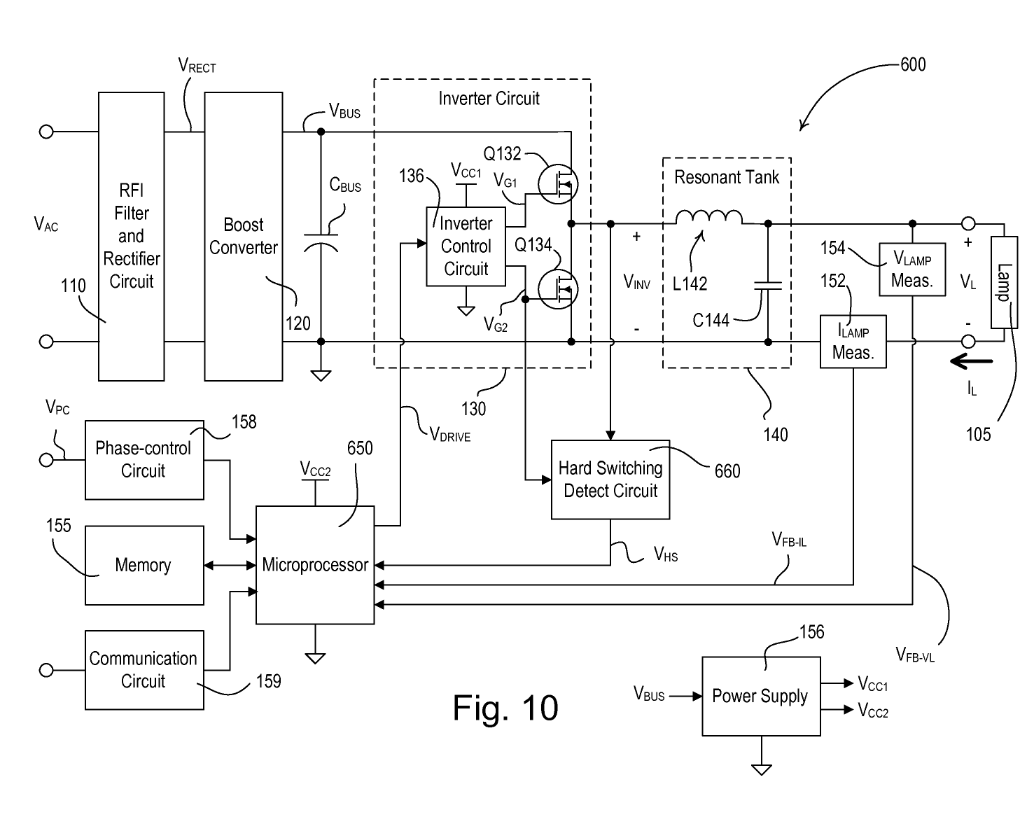

FIG. 10 is a simplified block diagram of an electronic dimming ballast 600 according to a second embodiment of the present invention. The ballast 600 of the second embodiment has many of the same functional blocks as the ballast 100 of the first embodiment. However, the ballast 600 comprises a hard switching detect circuit 660 that receives the inverter output voltage V_{INV} generated by the inverter circuit 130 and the gate voltage V_{G2} of the lower FET Q134. The hard switching detect circuit 660 generates a hard switching control signal V_{HS}, which is received by a microprocessor 650 and, as in the first embodiment, is representative of the amount of hard switching that is presently occurring in the FETs Q132, Q134.

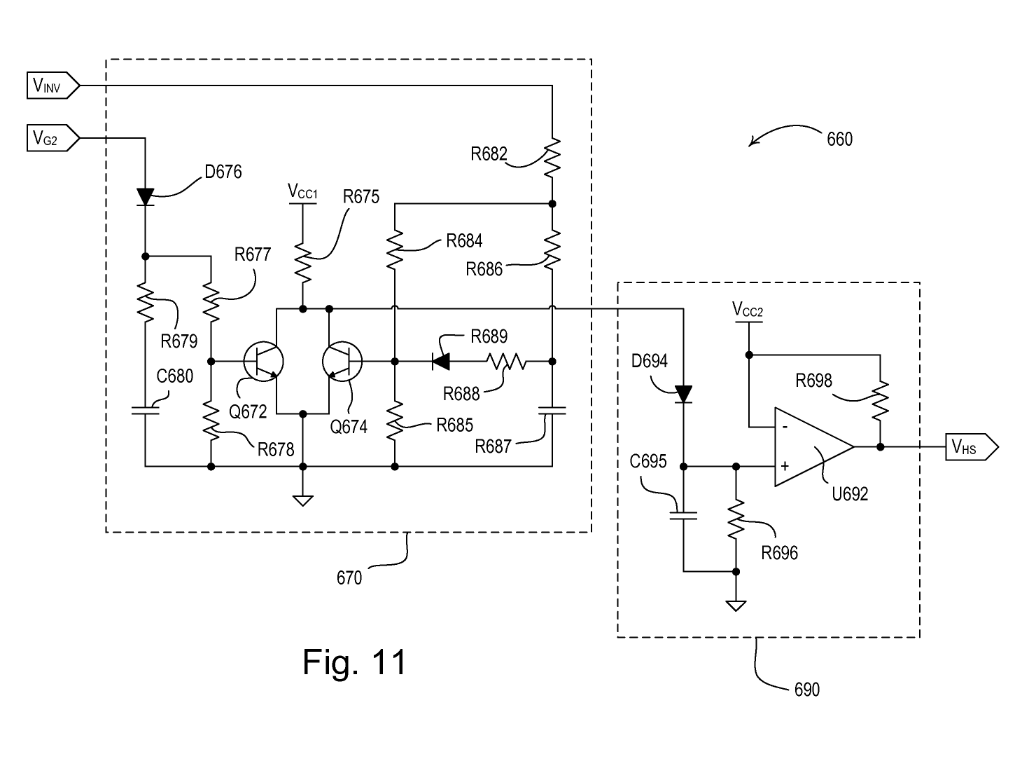

FIG. 11 is a simplified schematic diagram of the hard switching detect circuit 660 of the second embodiment. The hard switching detect circuit 660 comprises a differential amplifier circuit 670 that receives the inverter output voltage V_{INV} and the second gate voltage V_{G2} of the FET Q134. The output of the differential amplifier circuit 670 is received by a comparator circuit 690, which generates the hard switching control signal V_{HS}. The differential amplifier comprises two bipolar junction transistors (BJTs) Q672, Q674 that are coupled in parallel. The emitters of the transistors Q672, Q674 are coupled to circuit common, while the collectors are coupled to the first DC supply voltage V_{CC1} (i.e., approximately 15 volts) through a resistor R675 (e.g., having a resistance of approximately 1 kΩ).

The base of the transistor Q672 is coupled to the second gate voltage V_{G2} through a diode D676 and a resistor R677 (e.g., having a resistance of approximately 20 kΩ). A resistor R678 is coupled across the base-emitter junction of the transistor Q672 and has, for example, a resistance of approximately 3.3 kΩ. When the second gate voltage V_{G2} is driven high to approximately the first DC supply voltage V_{CC1}, the transistor Q672 is rendered conductive, and the output of the differential amplifier circuit 670 is pulled low towards circuit common. While the second gate voltage V_{G2} is high, a capacitor C680 (e.g., having a capacitance of approximately 18 pF) is able to charge to approximately the first DC supply voltage V_{CC1} through a resistor R679 (e.g., having a resistance of approximately 800 S2). When the second gate voltage V_{G2} is driven low to approximately circuit common, the capacitor C680 discharges through the resistors R677, R678, R679, such that the transistor Q672 remains conductive after the second gate voltage V_{G2} is driven low, for example, for approximately the wait time period T_{WAIT} (i.e., approximately 750 nanoseconds) as shown in FIG. 3. When the voltage at the base of the transistor Q672 drops below the rated base-emitter voltage, the transistor Q672 is rendered non-conductive, and the output of the differential amplifier circuit 670 is pulled high towards the first DC supply voltage V_{CC1}.

The base of the second transistor Q674 is coupled to the inverter output voltage V_{INV} through two resistors R682, R684 (e.g., having resistances of 225 kΩ and 20 kΩ), respectively. The base of the transistor Q674 is coupled to circuit common through a resistor R685 (e.g., having a resistance of approximately 3.3 kΩ). When the magnitude of the inverter output voltage V_{INV} exceeds, for example, the predetermined hard switching threshold V_{TH-HS} (i.e., approximately 36 volts), the transistor Q674 is rendered conductive, thus pulling the output of the differential amplifier circuit 670 low towards circuit common. The differential amplifier circuit 670 further comprises a capacitor C687 that has a capacitance of, for example, approximately 1 nF, and charges through a resistor R686 (e.g., having a resistance of approximately 10 kΩ). When the magnitude of the inverter output voltage V_{INV} is driven low towards circuit common, the capacitor C687 discharges through a diode D689 and a resistor R688 (e.g., having a resistance of approximately 560Ω), such that the transistor Q674 remains conductive after the inverter output voltage V_{INV} is driven low.

The comparator circuit 690 comprises a comparator U692 having a non-inverting input coupled to receive the output of the differential amplifier circuit 670 through a diode D694 and a resistor R695. When both of the transistors Q672, Q674 are non-conductive, a capacitor C695 (e.g., having a capacitance of approximately 0.1 μF) is operable to charge to approximately the first DC supply voltage V_{CC1}. When either of the transistors Q672, Q674 are conductive, the capacitor C695 is operable to discharge slowly through a resistor R696 (e.g., having a resistance of approximately 1 MΩ). The inverting input of the comparator U692 is coupled to the second DC supply voltage V_{CC2}. The hard switching control signal V_{HS} is generated at the output of the comparator U692, which is coupled to the second DC supply voltage V_{CC2} through a resistor R698 (e.g., having a resistance of approximately 2.7 kΩ).

When the magnitude of the inverter output voltage V_{INV} does not exceed the hard switching threshold V_{TH-HS} after the end of the wait time period T_{WAIT}, such that the transistors Q672, Q674 are both non-conductive, the output of the differential amplifier circuit 670 is pulled high towards the first DC supply voltage V_{CC1}. Accordingly, the voltage at the non-inverting input of the comparator U692 is greater than the second DC supply voltage V_{CC2} at the inverting input and the output of the comparator (i.e., hard switching control signal V_{HS}) is pulled high towards the second DC supply voltage V_{CC2}, thus signaling that an unacceptable amount of hard switching may be occurring in the FETs Q132, Q134.

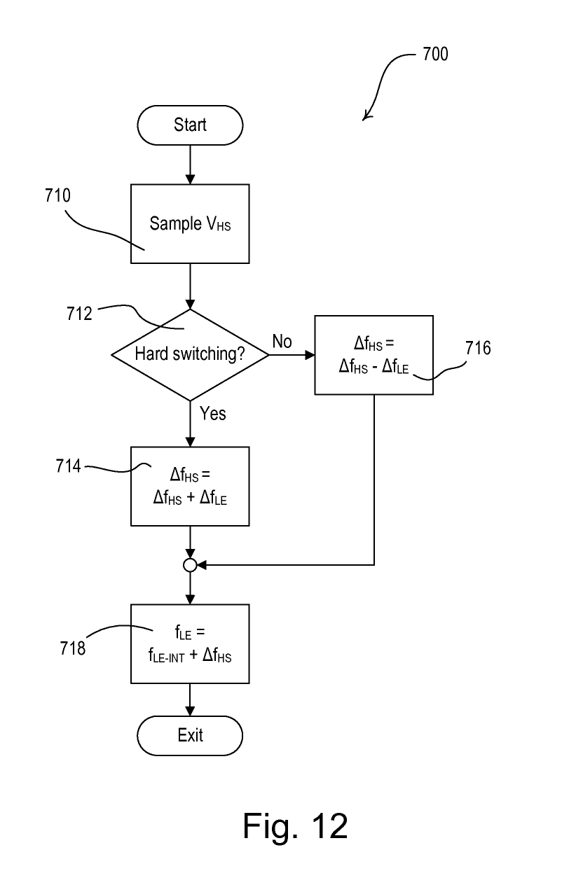

FIG. 12 is a simplified flowchart of a hard switching offset frequency adjustment procedure 700 executed by the microprocessor 650 periodically (e.g., every one second) according to the second embodiment of the present invention. The microprocessor 650 first samples the hard switching control signal V_{HS} at step 710. If the hard switching control signal V_{HS} is high (i.e., at approximately the second DC supply voltage V_{CC2}) at step 712 (i.e., signaling that hard switching may be occurring in the FETs Q132, Q134), the microprocessor 650 increases the hard switching offset frequency Δf_{HS} by the predetermined amount Δf_{LE} (i.e., approximately 1 kHz) at step 714. The microprocessor 650 then sets the low-end frequency f_{LE} to be equal to the initial low-end operating frequency f_{LE-INIT} plus the hard switching offset frequency Δf_{HS} at step 718, and the hard switching offset frequency adjustment procedure 700 exits. If the hard switching control signal V_{Hs} is low (i.e., at approximately circuit common) at step 712, the microprocessor 650 decreases the hard switching offset frequency Δf_{HS} by the predetermined amount Δf_{LE} (i.e., approximately 1 kHz) at step 716, before the microprocessor sets the low-end frequency f_{LE} to be equal to the initial low-end operating frequency f_{LE-INIT} plus the hard switching offset frequency Δf_{HS} at step 718 and the hard switching offset frequency adjustment procedure 700 exits.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An electronic ballast for driving a gas discharge lamp, the ballast comprising:
an inverter circuit for converting a DC bus voltage to a high-frequency inverter output voltage having an operating frequency and an operating duty cycle, the inverter circuit comprising first and second series-connected switching devices coupled between the bus voltage and circuit common, the first and second switching devices rendered conductive and non-conductive on a complementary basis, such that the high-frequency inverter output voltage is generated at the junction of the switching devices;
a resonant tank circuit operable to couple the high-frequency inverter output voltage to the lamp; and
a control circuit coupled to the inverter circuit for controlling the operating duty cycle of the high-frequency inverter output voltage, so as to adjust the intensity of the lamp to a target intensity;
wherein, when the intensity of the lamp is at or near a low-end intensity, the control circuit is operable to control the operating frequency of the high-frequency inverter output voltage to a low-end operating frequency that is low enough to ensure stable operation of the lamp and to allow some hard switching to occur in the switching devices of the inverter circuit, but high enough to prevent excessive power loss due to the hard switching in the switching devices of the inverter circuit.

2. The ballast of claim 1, further comprising:
a hard switching detection circuit coupled to the inverter circuit and the control circuit, the hard switching detection circuit operable to determine the amount of hard switching that is presently occurring in the switching devices of the inverter circuit, and to generate a control signal representative of the amount of hard switching that is presently occurring in the switching devices of the inverter circuit;
wherein the control circuit is operable to adjust the low-en operating frequency of the high-frequency inverter output voltage in response to the amount of hard switching that is presently occurring.

3. The ballast of claim 2, wherein the hard switching detection circuit receives the high-frequency inverter output voltage, such that the hard switching detection circuit is operable to determine the amount of hard switching that is presently occurring in the switching devices of the inverter circuit in response to the magnitude of the high-frequency inverter output voltage.

4. The ballast of claim 3, wherein the hard switching detection circuit is operable to determine the amount of hard switching that is presently occurring in the switching devices of the inverter circuit by comparing the magnitude of the high-frequency inverter output voltage to a predetermined threshold immediately before the first switching device is rendered conductive.

5. The ballast of claim 4, wherein the control circuit is operable to count the number of switching cycles of the inverter circuit that the magnitude of the high-frequency inverter output voltage is below the predetermined threshold, and to increase the low-end operating frequency of the high-frequency inverter output voltage by a predetermined amount when the number of switching cycles reaches a predetermined maximum number.

6. The ballast of claim 5, wherein the control circuit is operable to reset the low-end operating frequency of the high-frequency inverter output voltage to an initial low-end operating frequency when the low-end frequency has been increased to be greater than a maximum low-end operating frequency.

7. The ballast of claim 5, wherein the control circuit is operable to enable the hard switching detection circuit immediately before the first switching device is rendered conductive.

8. The ballast of claim 3, wherein the hard switching detection circuit is operable to determine that an unacceptable amount of hard switching may be presently occurring in the switching devices of the inverter circuit if the magnitude of the high-frequency inverter output voltage is below a predetermined threshold immediately before the first switching device is rendered conductive.

9. The ballast of claim 8, wherein the first switching device of the inverter circuit is coupled to the bus voltage and the second switching device is coupled to circuit common, the inverter circuit comprising an inverter control circuit for driving the first and second switching devices with respective first and second gate voltages.

10. The ballast of claim 9, wherein the hard switching detection circuit comprises a differential amplifier that receives the high-frequency inverter output voltage of the inverter circuit and the gate voltage the second switching device of the inverter circuit, the hard switching detection circuit further comprising a comparator circuit responsive to an output of the differential amplifier and operable to generate the control signal representative of the amount of hard switching that is presently occurring in the switching devices of the inverter circuit.

11. The ballast of claim 10, wherein the control circuit is operable to increase the operating frequency of the high-frequency inverter output voltage by a predetermined amount when an unacceptable amount of hard switching may be presently occurring in the switching devices of the inverter circuit.

12. The ballast of claim 11, wherein the control circuit is operable to decrease the operating frequency of the high-frequency inverter output voltage by a predetermined amount when hard switching is not occurring in the switching devices of the inverter circuit.

13. The ballast of claim 2, wherein the control circuit is operable to maintain the low-end frequency constant if an acceptable amount of hard switching is presently occurring in the switching devices of the inverter circuit.

14. The ballast of claim 13, wherein the control circuit is operable to increase the low-end operating frequency if an unacceptable amount of hard switching is presently occurring in the switching devices of the inverter circuit.

15. The ballast of claim 14, wherein the unacceptable amount of hard switching is presently occurring in the switching devices of the inverter circuit if reverse recovery is occurring.

16. The ballast of claim 2, wherein the first switching device of the inverter circuit is coupled to the bus voltage, the hard switching detection circuit operable to measure the amount of hard switching that is presently occurring in the switching devices of the inverter circuit by measuring the voltage across the first switching device.

17. The ballast of claim 2, wherein the second switching device of the inverter circuit is coupled to circuit common, the control circuit operable to measure the amount of hard switching that is presently occurring in the switching devices of the inverter circuit by measuring the current conducted through the second switching device.

18. The ballast of claim 1, wherein the control circuit is operable to detect whether reverse recovery may be presently occurring in the switching devices of the inverter circuit, and to increase the low-end operating frequency in response to detecting that reverse recovery may be occurring in the switching devices.

19. An electronic ballast for driving a gas discharge lamp, the ballast comprising:
an inverter circuit for converting a DC bus voltage to a high-frequency inverter output voltage having an operating frequency and an operating duty cycle, the inverter circuit comprising first and second series-connected switching devices coupled between the bus voltage and circuit common, the first and second switching devices rendered conductive and non-conductive on a complementary basis, such that the high-frequency inverter output voltage is generated at the junction of the switching devices;
a resonant tank circuit operable to couple the high-frequency inverter output voltage to the lamp;
a hard switching detection circuit coupled to the inverter circuit and operable to generate a control signal representative of an amount of hard switching that is presently occurring in the switching devices of the inverter circuit; and
a control circuit coupled to the inverter circuit for controlling the operating duty cycle of the high-frequency inverter output voltage, so as to adjust the intensity of the lamp to a target intensity, the control circuit further coupled to the hard switching detection circuit for receiving the control signal representative of the amount of hard switching that is presently occurring in the switching devices of the inverter circuit;
wherein, when the intensity of the lamp is at or near a low-end intensity, the control circuit is operable to control the operating frequency of the high-frequency inverter output voltage to a low-end operating frequency and to adjust the operating frequency of the high-frequency inverter output voltage in response to the control signal representative of the amount of hard switching that is presently occurring to ensure stable operation of the lamp, allow some hard switching to occur in the switching devices of the inverter circuit, and prevent excessive power loss due to the hard switching in the switching devices of the inverter circuit.

20. A method for driving a gas discharge lamp in an electronic ballast, the method comprising:
converting a DC bus voltage to a high-frequency inverter output voltage having an operating frequency and an operating duty cycle using first and second series-connected switching devices coupled between the bus voltage and circuit common, the first and second switching devices rendered conductive and non-conductive on a complementary basis, such that the high-frequency inverter output voltage is generated at the junction of the switching devices;
controlling the operating duty cycle of the high-frequency inverter output voltage so as to adjust the intensity of the lamp to a target intensity;
controlling the operating frequency of the high-frequency inverter output voltage to a low-end operating frequency when the intensity of the lamp is at or near a low-end intensity;
generating a control signal representative of an amount of hard switching that is presently occurring in the series-connected switching devices; and
adjusting the operating frequency of the high-frequency inverter output voltage in response to the control signal representative of the amount of hard switching that is presently occurring to ensure stable operation of the lamp, allow some hard switching to occur in the series-connected switching devices, and prevent excessive power loss due to the hard switching in the series-connected switching devices.

21. The method of claim 20, wherein generating a control signal representative of an amount of hard switching that is presently occurring in the series-connected switching devices comprises:
comparing the magnitude of the high-frequency inverter output voltage to a predetermined threshold immediately before the first switching device is rendered conductive; and
signaling that hard switching may be presently occurring in the series-connected switching devices if the magnitude of the high-frequency inverter output voltage is below the predetermined threshold.

22. The method of claim 21, wherein adjusting the operating frequency of the high-frequency inverter output voltage comprises:
counting the number of switching cycles of the series-connected switching devices that the magnitude of the high-frequency inverter output voltage is below the predetermined threshold;
increasing the operating frequency of the high-frequency inverter output voltage by a predetermined amount when the number of switching cycles reaches a predetermined maximum number.

23. The method of claim 22, wherein adjusting the operating frequency of the high-frequency inverter output voltage further comprises reseting the low-end operating frequency of the high-frequency inverter output voltage to an initial low-end operating frequency when the low-end frequency has been increased to be greater than a maximum low-end operating frequency.

24. The method of claim 20, wherein generating a control signal representative of an amount of hard switching that is presently occurring in the series-connected switching devices comprises signaling that an unacceptable amount of hard switching may be presently occurring in the series-connected switching devices if the magnitude of the high-frequency inverter output voltage is below a predetermined threshold immediately before the first switching device is rendered conductive.

25. The method of claim 24, wherein adjusting the operating frequency of the high-frequency inverter output voltage comprises increasing the operating frequency of the high-frequency inverter output voltage by a predetermined amount when an unacceptable amount of hard switching may be presently occurring in the series-connected switching devices.

26. The method of claim 25, wherein adjusting the operating frequency of the high-frequency inverter output voltage comprises decreasing the operating frequency of the high-frequency inverter output voltage by a predetermined amount when hard switching is not occurring in the switching devices of the series-connected switching devices.
